(19) United States
(12) Patent Application Publication
(10) Pub. No.: US 2022/0388244 A1
(43) Pub. Date: Dec. 8, 2022

(54) DEVICE FOR PROCESSING A BODY MANUFACTURED BY MEANS OF AN ADDITIVE MANUFACTURING

(71) Applicants: Dentsply Sirona Inc., York, PA (US); Sirona Dental Systems GmbH, Bensheim (DE)

(72) Inventor: Klaus STADLMANN, Wien (AT)

(21) Appl. No.: 17/776,733

(22) PCT Filed: Nov. 16, 2020
(86) PCT No.: PCT/EP2020/082278

§ 371 Date: May 13, 2022

(30) Foreign Application Priority Data
Nov. 15, 2019 (AT) A50992/2019

(51) Int. Cl. B29C 64/379; B33Y 40/00; B33Y 50/00; B29C 64/386; B26D 1/06

(52) U.S. Cl. CPC B29C 64/379; B33Y 40/00; B33Y 50/00; B29C 64/386; B26D 1/06

(57) ABSTRACT

A device (1) is for processing a body (4) manufactured by an additive manufacturing method from a liquid substance curable by radiation. The device (1) includes a holder (3) for a build platform (2). The device (1) also includes a separating device (5) for separating a body (4) arranged on a build platform (2) held by the holder (3) from the build platform (2), and a method and use employ the device.

The invention relates to a device for processing a body manufactured by means of an additive manufacturing method from a liquid substance curable by radiation, the device comprising a holder for a build platform, and a method for processing a body manufactured by means of an additive manufacturing method from a liquid substance curable by radiation using such a device and a specific use of a more general device.

Devices and methods for building up a three-dimensional body in layers from a liquid substance curable by radiation are also known under the terms 3D printing, additive manufacturing or rapid prototyping. The substance concerned may be liquid at normal temperature and pressure (being a temperature of 20° C. and an absolute pressure of 101.325 kPa). In general, said substance may also be non-liquid, also at the same conditions. This disclosure is not limited to a particular state of aggregation of the substance curable by radiation. The substance will take a solid state of aggregation after curing by radiation. Specifically, the invention relates to a device and method for processing a body manufactured by means of stereolithography from thermoset polymers or “resins”.

The cross-sectional information of the substance to be cured in layers by electromagnetic radiation of suitable wavelength and intensity, for example, a photo resin, is thereby generally created by a mask projection method or by a laser source. In generative production machines that enable such a printing process, pixel-controlled DLP (digital light processing), MEMS (microelectromechanical systems), LC (liquid crystal) displays, LED displays or controllable lasers are mostly used for the exposure of the cross-section of the layers. The exposure thereby generates a solid layer from the liquid, photosensitive substance. This layer adheres to a carrier and is detached or removed from a reference surface by lifting the carrier. In all subsequent production steps, the cured layer, detached from the reference surface, functions as a carrier. A three-dimensional body is thus successively drawn or formed from the photosensitive substance.

After the successful printing process, the three-dimensional body created still has to be successively post-processed. The successive steps are known as the collective term “post-processing”. After the post-processing has been carried out successfully, the body still has to be separated from the build platform. This is currently done manually by the user of the machine. For example, the build platform is turned over so that the body faces upwards. The build platform must be fixed and the user must manually separate the body from the platform with the help of a spatula. The user can slip off, injure himself and damage the component at any time. The production process also comes to a halt during the time span until the user has detached the component manually, which lowers productivity, especially in build processes that run overnight. The separating force applied by the user can vary, depending on the type of material. The component can easily break, depending on the type of material and/or geometry (very brittle).

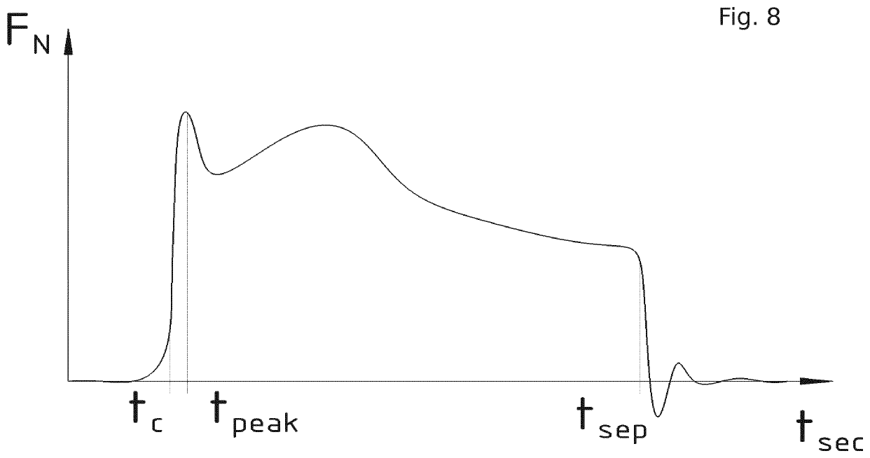

AT 516324 B1 relates to a machine for manufacturing a body from photo-curable material and a special build platform. This build platform has grooves in the XY direction that form the individual pins or teeth on which the component adheres. The components are separated via a type of scraper, with the help of which the components can be broken off the build platform manually without additional tools. See also FIGS. 8a and 8b.

Concerning a different type of processes for additive manufacturing making a body on top of a printing surface, EP 3 392 026 A1 shows a part removal blade supported for motion across the printing surface to release the part from the top of the printing surface. For a similar application CN 207105641 U shows a blade that is used to automatically cut and scrape off the product on the worktable.

More specifically, in connection with additively built three-dimensional objects generated by consolidating metal, ceramic or polymer powder, US 2019/283161 A1 discloses separating the built objects from a substrate plate by using wire-cut electric discharge machining (EDM) or a band saw. EP 3 608 084 A1 shows a separating element, for example a band saw blade, that cuts vertically through the built objects to separate them from a build plate.

Known devices and methods for separating bodies built up in layers are not automated and do not allow any monitoring or control of individual steps of the separation process based thereon, so there is a need for improved and completely automated separating devices. Particularly on separating devices that allow full automation of the printing process and the body to be formed is intrinsically output without the need for the user to intervene in the production process.

It is now an object of the invention to create a device and a method as indicated at the outset, which enables the separation and thus the automatic detachment of, for example, bodies built up in layers.

For this purpose, the invention provides a device as defined in claim 1 and a method as defined in claim 15 and a use as defined in claim 19. Advantageous embodiments and developments are specified in the dependent claims.

According to the invention, the device comprises a separating device for separating a body arranged on a build platform held by the holder from the build platform. A holder is understood here to mean any device to which something can be fastened or which holds something (at a certain point). The device can therefore itself comprise a build platform or a receptacle, particularly a coupling, for a removable build platform. During operation of the device and separation of the body, the body may be suspended from the build platform. I.e. the holder may be suitable to support a body suspended from a build platform held by the holder. The separating device may be configured to separate the body from the bottom of the build platform under the force of gravity pulling the body away from the build platform.

The separating device can comprise a shearing device, the shearing device comprising a separating edge, the device also comprising a drive for a relative movement between the holder and the shearing device. The drive can be formed by one or a plurality of motors, for example, electric motors. The drive can be controlled differently, for example, at opposite ends of a separating edge, for example, in order to change an angle of attack of the separating edge on the body.

The drive can be configured to move the shearing device.

The drive can alternatively be configured to move the holder.

The device can comprise a stop for stripping and/or peeling off the body from the build platform.

The device can comprise a force sensor which is configured to capture a force acting on the body during a separation. In this context, a force sensor is understood to be any sensor that captures or ascertains the force or a parameter that is related to the force and from which a force can be derived or detected (which corresponds to an indirect force measurement). The invention is not restricted to a specific physical measuring principle. The force sensor can be arranged, for example, in order to capture a separating force or the force of the separating device on the body (or vice versa) in at least one spatial direction. Particularly, using the force sensor, a force can be captured and optionally recorded as a function of a relative arrangement of the holder and the separating device. Within the scope of the invention, a plurality of force sensors, for example, one force sensor each at opposite ends of a separating edge, can be provided in order to enable the force to be captured in a location-dependent manner.

The force sensor can be connected to the separating device and can be configured to capture a force exerted by the separating device. A force can, for example, be exerted on a body to be separated, another obstacle on the build platform or the build platform itself. The case where the separating device has no resistance corresponds to free movement and is also captured or detected by the force sensor.

The force sensor can be connected to the holder and can be configured to capture a force exerted by the holder. A force can be exerted, for example, by a drive of the holder, or on the body and from there on the holder via the build platform. The force sensor can be configured particularly to capture a force component in the plane of a build area of the build platform. The case where the holder has no resistance corresponds to free movement and is also captured or detected by the force sensor.

The force sensor can be connected to a processing unit for outputting process parameters based on the force signal and/or optionally for controlling a drive. In the latter case, the processing unit is a control device of the drive for a relative movement between the holder and the shearing device. In general, the processing unit is connected to the force sensor and is configured to process a force signal captured by the force sensor. In the case of a control of the drive for a relative movement, the feed provided by the drive can be adapted as a function of the force signal of the force sensor. This adaptation can take place, for example, on the basis of a comparison with an expected value. For example, a feed rate of the separating device and/or the holder, a feed acceleration and/or a process time can be adapted. In the case of a drive comprising a plurality of motors, the individual motors can also be controlled differently as a function of the force signal, for example, alternately, above a force threshold value, or individually on the basis of a spatially resolving force signal (for example, with a plurality of force sensors). The expected value can optionally in turn be known as a function of time, the feed and/or statistically or it can be calculated on the basis of a model of the body.

The force sensor can comprise a strain gauge.

The device can comprise a collecting unit which is arranged in such a way that a body separated from the build platform using the separating device is collected in the collecting unit after separation.

The collecting unit can be connected to a weight sensor, the weight sensor being configured to capture the weight of a body collected by the collecting unit. The captured weight can be compared using a processing unit with a predefined expected value or an expected value calculated using a model, and when the deviation is too great, an error message can be output, for example, or the manufacture of the body can be repeated. In other words, the receptacle of the body to be separated can be provided with a height-adjustable depositing device for receiving the separated body, which device can comprise a further force sensor.

The collecting unit can be connected to an actuator, the actuator being configured to bring a receptacle of the collecting unit up to a body to be separated in at least one spatial direction (i.e. the actuator may be configured to approach the body with the receptacle). As a result, the height of fall of the separated body can be reduced and optionally adapted depending on the linear expansion of the body.

The separating device can be mounted in a suitable manner in order to compensate for unevenness and/or positioning errors and/or incorrect positions or orientations of the build platform. For example, a shearing device can be mounted in a spring-loaded manner so that a separating edge is pressed against a build area of the build platform during use. Optionally, the shearing device can be pivotably mounted in order to be able to follow any pivoting movements of the build platform.

In the disclosed method of the type mentioned at the outset, a body arranged on a build platform held by the holder can be separated from the build platform by means of the separating device.

The separating device can comprise a shearing device, the shearing device comprising a separating edge, the device also comprising a drive for a relative movement between the holder and the shearing device, and the body being sheared from the build platform using the separating edge under the action of the drive.

The device can comprise a force sensor, the force acting on the body being captured using the force sensor during the separation of the body from the build platform.

The drive for the relative movement between the holder and the shearing device can be controlled on the basis of a force signal from the force sensor.

In the disclosed use of a device for processing a body manufactured by means of an additive manufacturing method from a liquid substance curable by radiation, the device comprising a transport device comprising a drive for moving a build platform, the device comprising a stop for stripping and/or lifting the body off from the build platform, it is provided that the body is stripped and/or lifted off from the build platform under the action of the drive over the build platform and under the action of the stop. To lift off, for example, a stop can be used that is spaced from the build platform and causes a torque on the contact surface between the body and the build platform.

According to the disclosure, it can be provided that the separating device comprises a blade, the force of which exerted on the body and/or on the build platform can be captured over time via a sensor, the blade being able to be moved by an actuator or feed device and that a container which can also comprise a sensor which is able, for example, to capture the weight of a separate body and which can be moved in height by a further actuator, at least one sensor being able to be used in connection with the control device to capture a force signal and thus the feed rate and/or acceleration being able to be optimized.

According to an optional embodiment of the device, the sensor can be connected to a processing unit which is configured to process the force-related value captured by the sensor. The processing unit can comprise a microprocessor or a microcontroller for this purpose. In addition, the processing unit can be connected to a data memory which contains data and/or program commands for processing the force values captured using the force sensor. The processing unit can be connected to an input/output device, for example, a touchscreen, for the operation of the processing unit by an operator. Actions and optimizations required for the separation of the body can be executed automatically by providing the processing unit.

In order to be able to control the device appropriately, it can be provided that the sensor is coupled via the processing unit with the drive unit or feed unit of the blade and optionally with a sensor for the height-adjustable collecting container and at least one drive unit, preferably that is connected to the blade and can be controlled as a function of the force value captured by the force sensor. The force values captured by the force sensor can thus be transmitted to the processing unit and processed therein.

The drive unit can make it possible to move the blade in at least one axis, optionally on the basis of the captured sensor data. Optionally, the drive unit is designed to separate at least one body from the build platform by a mainly linear movement. The drive unit can comprise an electric motor, for example a stepper motor, which is connected to a linear axis and thus enables the blade to move in the plane. The drive can comprise an encoder.

In order to be able to control the device, it can also be provided that the force sensor is coupled via the processing unit to a database that has the original information (CAD data; volume, material density, weight) of the body in order to determine, with the help of the sensor connected to the collection tray (for example, a force sensor or weighing cell) whether a body was successfully separated from the build platform and was collected in the collection tray.

At least one strain gauge, a so-called strain gauge sensor or a strain gauge bridge can be used to determine a force value for a cost-effective implementation. Conclusions can be drawn about the force progression by measuring variables related to the force value (for example, motor current).

With regard to the method, it can also be provided according to the disclosure that the sensor is a force sensor, the force for separating at least one body from the build platform and/or the weight of the already separated body in the collection tray being able to be captured using the force sensor.

In order to enable a force-controlled separation of the body from the build platform, the force sensor, which is provided for capturing the separating force, can be read by the control unit at least in a time interval of, for example, 0.01 s to 60 s or continuously and, when necessary, are compared with a target value and/or a maximum value.

According to a further embodiment of the separating device, it can be provided that a determined force value is compared with a target value for the separating force from a database, so that the optimal separating speed or a permissible force value can be determined, for example, depending on the material used, with which a blade feed should or not occur. This is also conceivable when a plurality of production cycles of the same build job is to be carried out, as errors can be inferred from the signals already captured.

In addition, an expected value of a force signal depending on the component and/or material can be calculated by the processing unit from the geometry and/or the material data.

Particularly, it can be provided that the captured force signal can be used to capture the separation of a component and/or a plurality of components on the basis of the data from a database with the aid of the collection tray and the associated sensor. For example, the weight measured in the collection tray increases with each body successfully detached from the build platform.

Furthermore, it can be provided that, depending on the height of the body, the distance between the build platform and the collection tray/collecting device can be set with the help of a lifting movement, namely in such a way that when there is a separation, the height of fall of the body or the distance between the body and the collecting tray can be adapted.

According to a further embodiment of the method, it can be provided that, in the case of a plurality of separations, the number of separated bodies can be determined as a function of the force value captured by the sensor.

Furthermore, it can be provided that a conclusion about the state of the component separation and/or the state of the build platform can be made from the force signal captured using the sensor. With the help of the force sensor, after a separation process, residues on the build platform can be inferred from the force acting on the blade and any occurring additional unexpected force signals when the direction of movement of the blade is reversed.

In a further embodiment of the invention, the blade can be mounted such that it enables height compensation or tolerance compensation in relation to the build platform. This can be done, for example, by a spring mounting or a spring-loaded suspension of the blade.

According to a further embodiment of the device, it can be provided that a captured or determined force value is compared with a maximum permissible value during the movement/positioning of the blade in order to prevent collisions or damage.

Particularly, it can be provided that the separating device specifies a maximum permissible separating force via the control device with the help of the known component data, which separating force must not be exceeded during the separation process. The separation process can be carried out iteratively, this means, for example, that when the maximum separating force is reached, the blade is stopped by the control unit and then, after the force has decreased, that is, so when an at least partial separation of the component from the build platform occurs, the feed is continued again. The speed ramps and/or the acceleration ramps can also be specified by the control unit depending on the force progression. The separation process can thus take place gently and damage to the component can be prevented.

When the description refers to the terms height, horizontal, vertical, top, bottom, above or below, these terms or other location or directional specifications are to be understood in the position of use of the device.

In order to avoid repetition of the part of the description relating to the device, reference is also made to the previous description of the device with regard to the description of the method, insofar as it is applicable to the method.

The disclosed method is used for the automatic separation and, optionally, collection of at least one body built up in layers from a liquid substance curable by radiation, for example, a light-curing resin, from a build platform.

The body formed by the 3D printing process adheres to the build platform, for example. If the generatively manufactured body is to be used for its intended purpose, it must be separated from the build platform in order to finally use it. The body is presently removed from the build platform by the user himself with the help of a spatula. Depending on the material and geometry, the spatula is applied by the user according to feeling. The separation of the component can be successful or less successful depending on the experience and feeling of the user.

According to an optional embodiment of the method, it can be provided that the force captured using the force sensor is compared with an expected value of the force in a processing unit connected to a force sensor and at least one method parameter is set as a function of the difference between the captured force value and the expected value. The value of the method parameter can be captured by the force sensor. Particularly, by repeatedly comparing the force value captured using the force sensor with the expected value and/or a range of an expected value of the force, the method parameter can be set or regulated to a target value of the separating force. The method parameter can be set by the processing unit itself or controlled thereby.

For example, the expected value of the force can be calculated or specified by the processing unit as a function of at least one method parameter. Accordingly, an expected force value can be calculated by the processing unit for a specific value of a method parameter or for a plurality of specific values of a plurality of process parameters. The processing unit can also calculate a series of expected values of the force for a series of specific values of one or more method parameters. The calculation can be carried out by means of simulation software, for example, using the component weight, the adhesive surface of the component and/or the material used. Thus, in combination with a collecting unit comprising a sensor, the successful and, above all, complete and/or only incomplete separation from the build platform can be detected or captured via the component weight.

Alternatively, a relative and/or absolute change in the force value in the course of the separation process can also be used to control the aforementioned process variables.

Optionally, it can be provided that the number of components generated on the build platform can be determined from the separating force captured using the sensor and/or the weight captured by the collection tray with the help of the sensor, and thus a conclusion can be drawn about a successful build process. It can therefore be determined whether the printing process corresponding to the 3D data was carried out successfully and completely. The coordinates at which an expected force value should occur can be determined by combination with the separating force and a linear axis with encoder. If this does not occur at the corresponding point, either no body is present at this point and/or the body has at least partially detached from the build platform. If this is the case, the first value for the separating force occurs at a point other than the one expected.

The invention is explained in more detail in the following using preferred, non-limiting exemplary embodiments with reference to the drawings. Shown are:

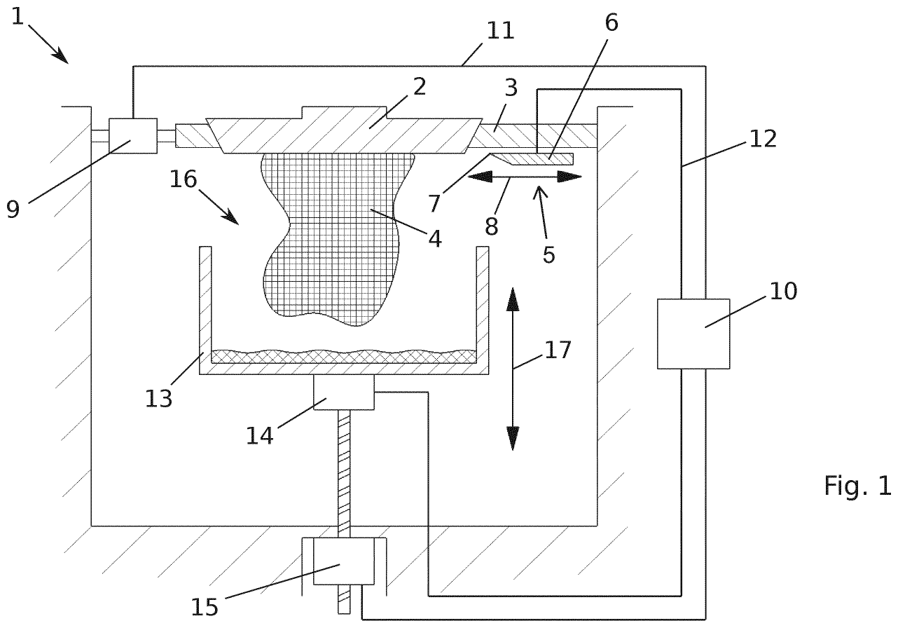

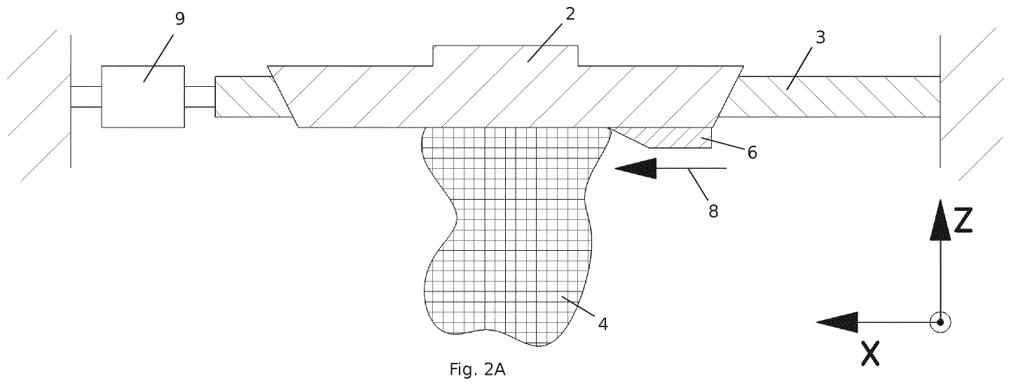

FIG. 1 schematically a device according to the invention for processing a body manufactured by means of an additive manufacturing method from a liquid substance curable by radiation and for separating the body from a build platform using a separating device;

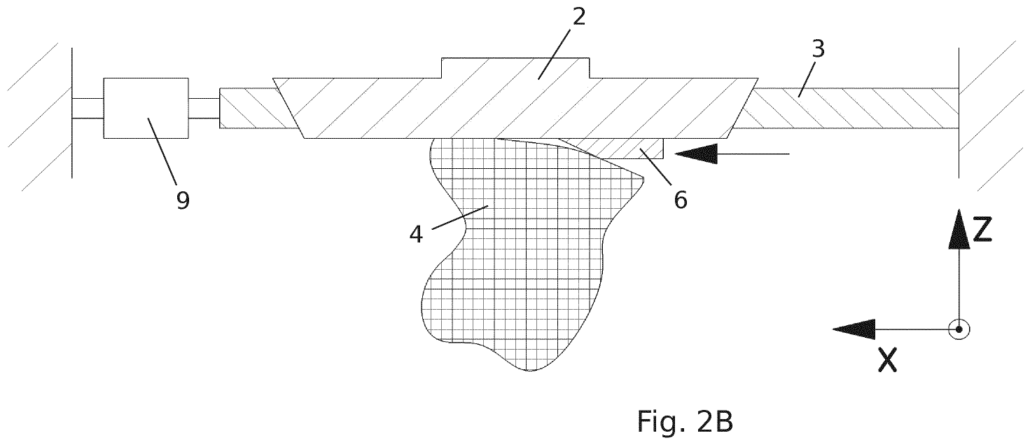

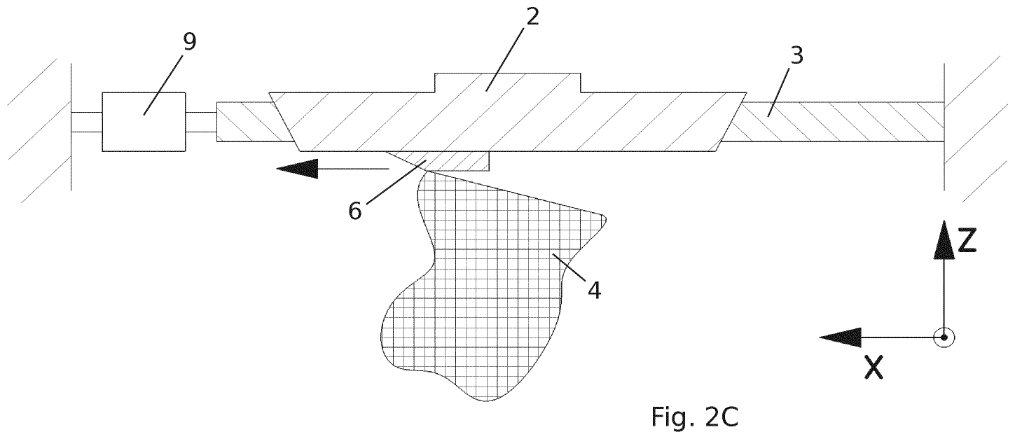

FIGS. 2A-C schematically a separation process, wherein in FIG. 2A, the separating device touches the body, in FIG. 2B, the body has been partially sheared off, and in FIG. 2C, the body is completely sheared off;

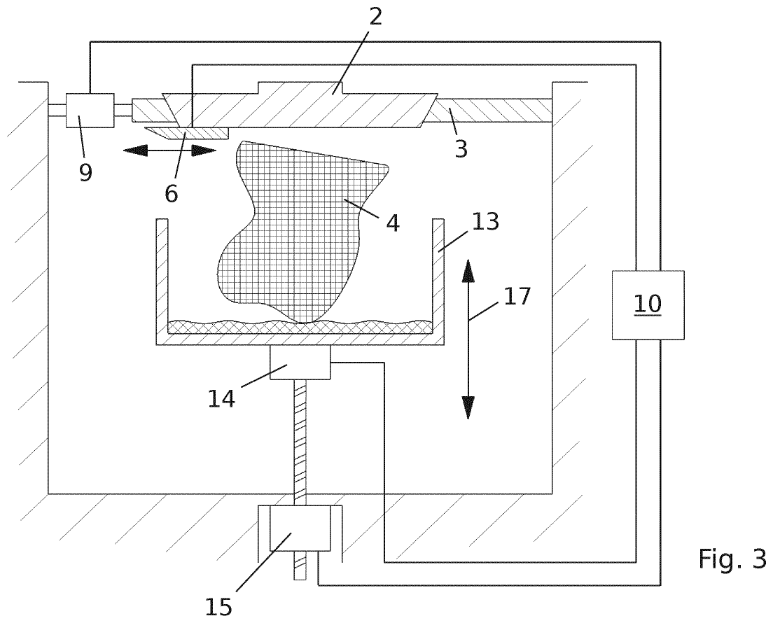

FIG. 3 schematically the device according to FIG. 1 at the moment when the body is collected in the collecting unit;

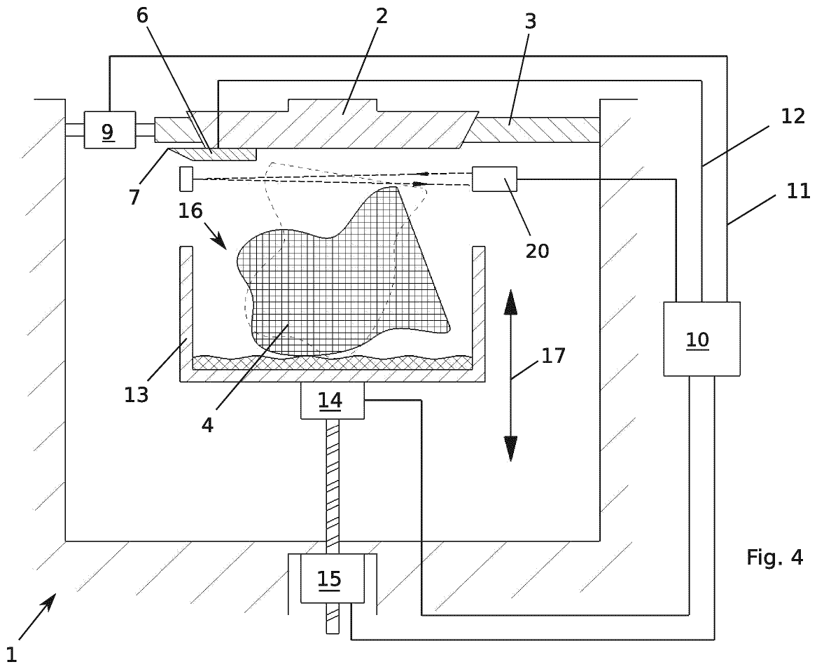

FIG. 4 schematically a device which is slightly modified with respect to FIG. 1 and has a light barrier which detects the complete detachment of the body from the build platform;

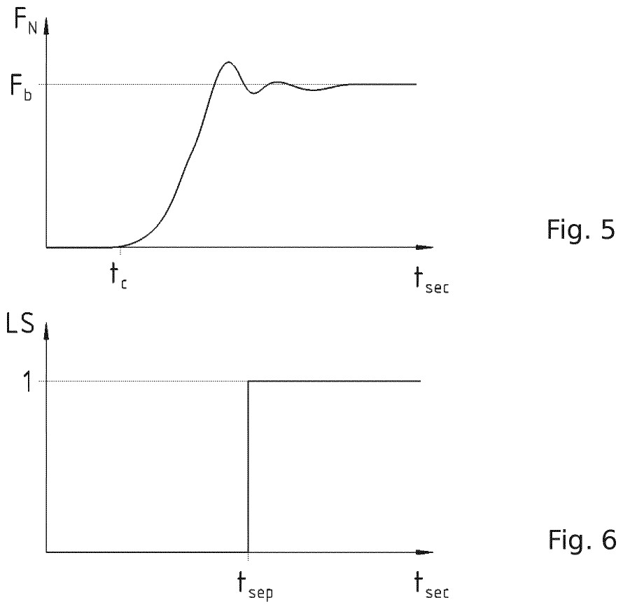

FIG. 5 schematically a diagram having an exemplary time profile of a force signal of a force sensor according to FIG. 1, for an already advanced but not yet fully completed separation process of a body from the build platform;

FIG. 6 schematically a diagram of the signal of the light barrier according to FIG. 4;

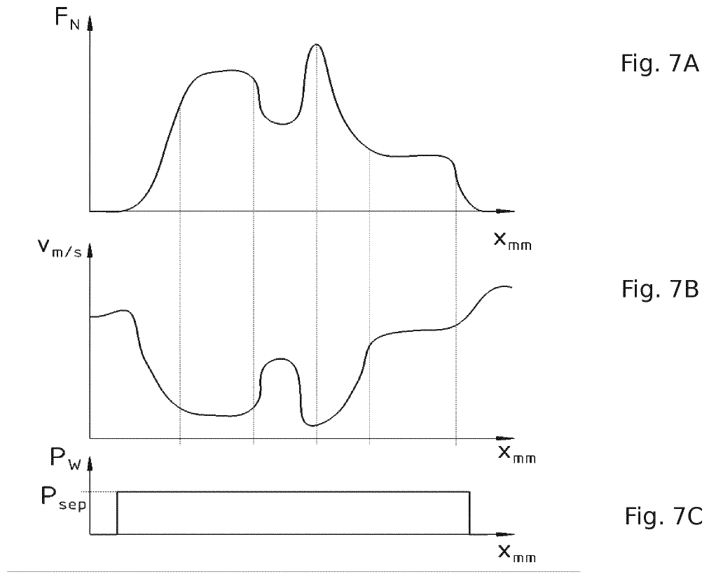

FIGS. 7A-C schematic diagrams of an adaptive speed control based on the force signal;

FIG. 8 schematically a diagram having a time profile of a force signal, which shows the complete separation of a component from the build platform;

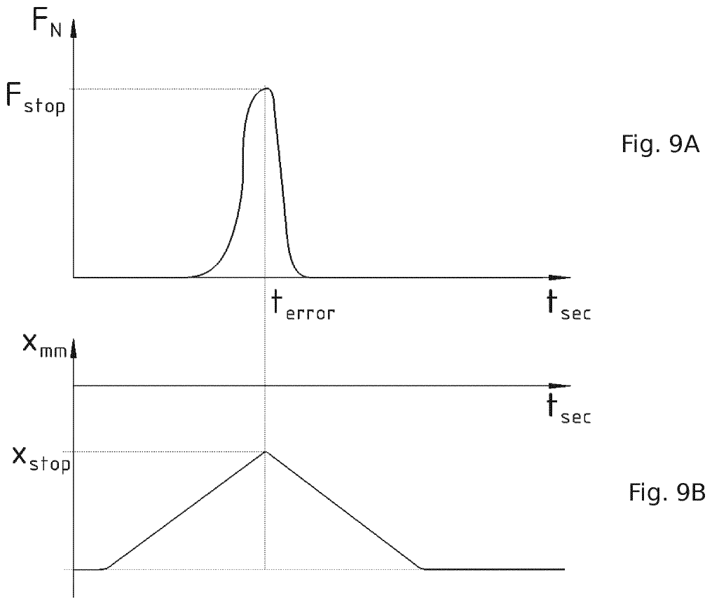

FIGS. 9A and 9B schematic diagrams of a situation according to FIG. 2A in which a maximum predetermined separating force is exceeded and the separation process is terminated;

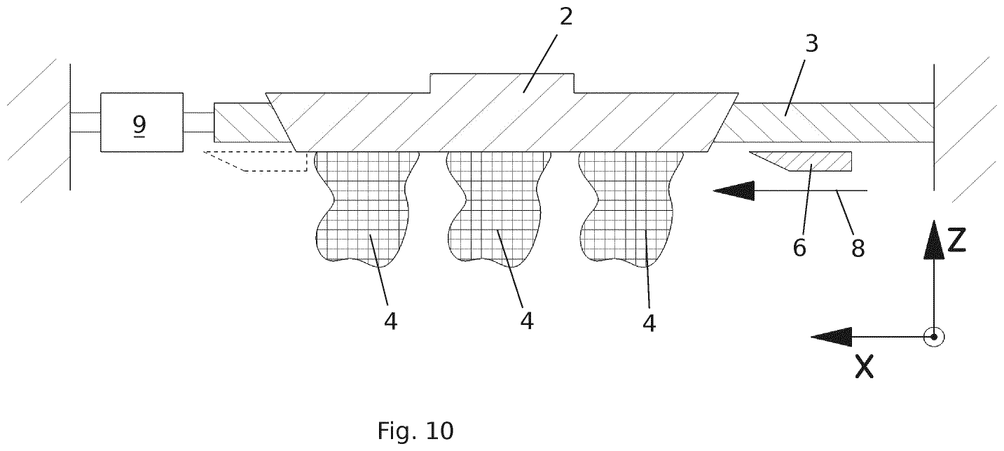

FIG. 10 schematically a build platform having a plurality of bodies which are separated by the shearing device and

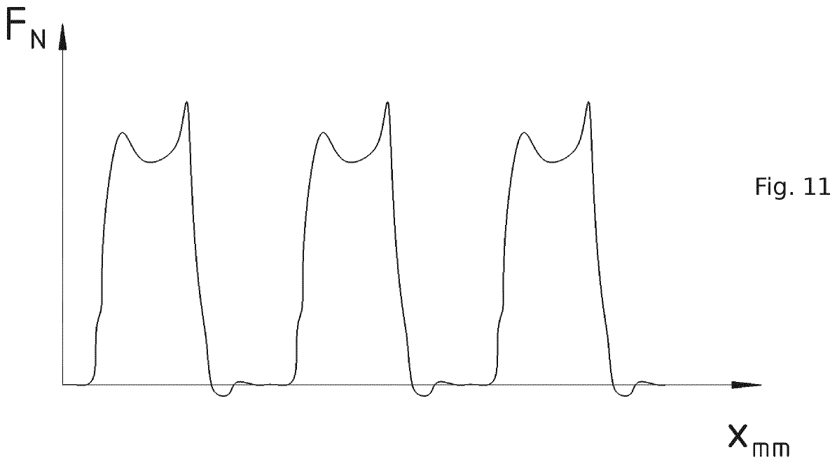

FIG. 11 schematically the time profile of the force signal captured by the force sensor;

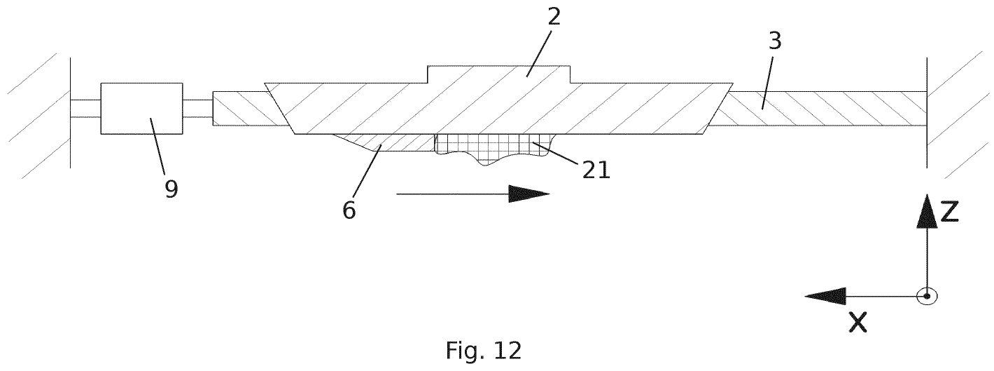

FIG. 12 schematically shows a build platform having residues which indicate an incomplete separation; and

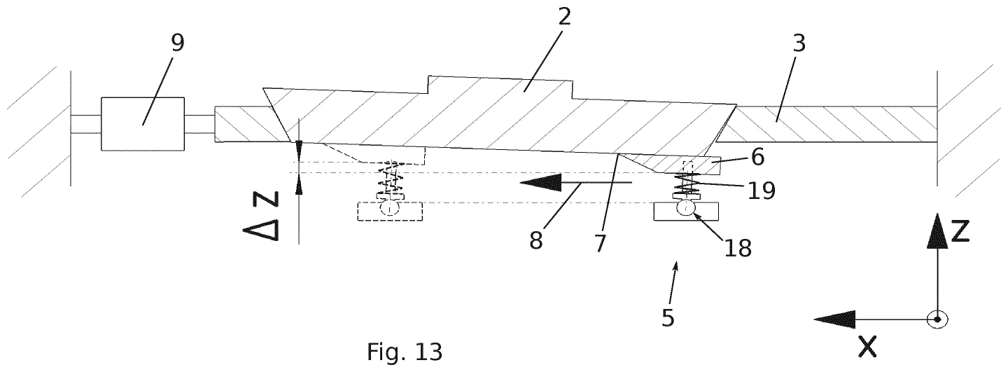

FIG. 13 schematically a pivotable and spring-loaded mounting of a shearing device.

With reference to the above description and the terms used there, the elements of the specific, only exemplary embodiments shown in the drawings are: a device 1 for processing a body 4 manufactured by means of an additive manufacturing method from a liquid substance curable by radiation; a build platform 2; a holder 3 for the build platform 2, that is, which holds the build platform 2; a separating device 5 for separating a body 4 arranged on and adhering to the build platform 2 from the build platform 2; a shearing device 6 comprising a separating edge 7; a drive (not shown) for a relative movement between the holder 3 and the shearing device 6 along a direction of movement 8 of the shearing device 6; a force sensor 9; a light barrier 20; and contamination 21 adhering to the build platform, for example, in the form of a material residue.

The build platform 2 is mounted spring-loaded, horizontally displaceable and the force sensor 9 can capture the deflection of this suspension. The force sensor 9 is connected to the holder 3 and is configured to capture a force exerted by the holder 3, more precisely the counterforce applied by the spring-loaded mounting against the force of the drive of the shearing device 6. The force sensor 9 is connected to a processing unit 10 (connection line 11). The processing unit 10 can output process parameters on the basis of the force signal and control the drive of the shearing device 6 (connecting line 12). The force sensor 9 comprises a strain gauge.

The device 1 comprises a collecting unit 13. The collecting unit 13 is arranged such that a body 4 separated from the build platform 2 using the separating device 5 is collected in the collecting unit 13 after separation. In order to avoid damage to the body 4, padding is provided on the bottom of the collecting unit 13. The collecting unit 13 is connected to a weight sensor 14. The weight sensor 14 is configured to capture the weight of a body 4 collected by the collecting unit 13. The collecting unit 13 is also connected to an actuator 15, for example, to a rack (i.e. a linear gear). The actuator 15 is configured to bring a receptacle 16 of the collecting unit 13 in at least one spatial direction 17 to a body 4 to be separated (or to a build platform 2 supporting it). The separating device 5 is suitably mounted in order to compensate for unevenness and/or positioning errors and/or incorrect positions or orientations of the build platform 2, see mount 18 and spring 19 in FIG. 13.

The following terms were used in the diagrams: FN is the force signal captured by the force sensor 9; Fb is the suitable detachment force that can be applied by the shearing device 6 without causing damage to the body 4 or the build platform; tc is the point in time of the first contact of the shearing device 6 with the body 4; tsec is the time axis in seconds; LS is the signal from the light barrier 20; tsep is the point in time when the body 4 is completely separated from the build platform 2; xmm is the position of the shearing device 6 relative to the build platform 2 in millimeters; vm/s is the speed of the shearing device relative to the build platform 2; P is the power in watts; Psep is the specified detachment power to be regulated; tpeak is the point in time of the maximum force signal; Fstop is a maximum permissible force and a force threshold above which the separation process is interrupted due to an error; terror is the point in time at which an error occurs; xstop is the position of the shearing device 6 at the point in time time of the error; z is a Cartesian coordinate normal to the plane of the build area of the build platform 2 in a reference state (as shown in FIG. 1); Δz is a distance in the z coordinate; x and y are the coordinates in the plane of the build area.

In the illustrated figures, parts of the device that do not serve to describe the respective figure have been omitted for the sake of clarity.

1. A device for processing a body manufactured by an additive manufacturing method from a liquid substance curable by radiation, the device comprising a holder for a build platform, wherein the device comprises a separating device for separating a body arranged on the build platform held by the holder from the build platform.

2. The device according to claim 1, wherein the separating device comprises a shearing device, wherein the shearing device comprises a separating edge, wherein the device also comprises a drive for a relative movement between the holder and the shearing device.

3. The device according to claim 2, wherein the drive is configured to move the shearing device.

4. The device according to claim 2, wherein the drive is configured to move the holder.

5. The device according to claim 1, wherein the device comprises a stop for stripping and/or peeling off the body from the build platform.

6. The device according to claim 1, wherein the device comprises a force sensor which is configured to capture a force acting on the body during a separation.

7. The device according to claim 6, wherein the force sensor is connected to the separating device and is configured to capture a force exerted by the separating device.

8. The device according to claim 6, wherein the force sensor is connected to the holder and is configured to capture a force exerted by the holder.

9. The device according to claim 6, wherein the force sensor is connected to a processing unit for outputting process parameters based on the force signal.

10. The device according claim 6, wherein the force sensor comprises a strain gauge.

11. The device according to claim 1, wherein the device comprises a collecting unit which is arranged such that a body separated from the build platform using the separating device is collected in the collecting unit after separation.

12. The device according to claim 11, wherein the collecting unit is connected to a weight sensor, wherein the weight sensor is configured to capture the weight of a body collected by the collecting unit.

13. The device according to claim 11, wherein the collecting unit is connected to an actuator, wherein the actuator is configured to bring a receptacle of the collecting unit up to a body to be separated in at least one spatial direction.

14. The device according to claim 1, wherein the separating device is mounted to compensate for unevenness and/or positioning errors and/or incorrect positions or orientations of the build platform.

15. A method for processing a body manufactured by an additive manufacturing method from a liquid substance curable by radiation using a device according to claim 1, wherein a body arranged on a build platform held by the holder is separated from the build platform by the separating device.

16. The method according to claim 15, wherein the separating device comprises a shearing device, wherein the shearing device comprises a separating edge, wherein the device also comprises a drive for a relative movement between the holder and the shearing device, and wherein the body is sheared off from the build platform using the separating edge under the action of the drive.

17. The method according to claim 15, wherein the device comprises a force sensor, and during the separation of the body from the build platform, the force acting on the body is captured using the force sensor.

18. The method according to claim 16, wherein the drive for the relative movement between the holder and the shearing device is controlled based on a force signal from the force sensor.

19. A method for processing a body manufactured by an additive manufacturing method from a liquid substance curable by radiation, the device comprising a transport device comprising a drive for moving a build platform, the device comprising a stop for stripping and/or lifting the body off from the build platform, the method comprising stripping the body and/or lifting the body off from the build platform under the action of the drive over the build platform and under the action of the stop.

20. The device according to claim 6, wherein the force sensor is connected to a processing unit for outputting process parameters based on the force signal and/or for controlling a drive.
